(19) United States
(12) Patent Application Publication
(10) Pub. No.: US 2001/0035502 A1
(43) Pub. Date: Nov. 1, 2001

(54) Radiation image storage panel and cassette

(76) Inventors: Satoshi Arakawa, Kaisei-machi (JP); Naoto Iwakiri, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/804,080

(22) Filed: Mar. 13, 2001

(30) Foreign Application Priority Data
Mar. 13, 2000 (JP) 068062/2000

(51) Int. Cl. G03B 42/02

(52) U.S. Cl. 250/484.4

(57) ABSTRACT

A radiation image storage panel having a rectangular shape comprises a transparent substrate and a stimulable phosphor layer over laid on a front surface side of the transparent substrate. The shape of the radiation image storage panel is asymmetric with respect to a center axis of the radiation image storage panel, which center axis extends in an antero-posterior direction of the radiation image storage panel, such that front and back surfaces of the radiation image storage panel can be clearly discriminated from each other.

### BACKGROUND OF THE INVENTION

1. Field of the Invention

This invention relates to a radiation image storage panel, which comprises a transparent substrate and a stimulable phosphor layer overlaid on a front surface side of the transparent substrate. This invention also relates to a cassette for accommodating the radiation image storage panel.

2. Description of the Related Art

It has been proposed to use stimulable phosphors in radiation image recording and reproducing systems. Specifically, a radiation image of an object, such as a human body, is recorded on a sheet provided with a layer of the stimulable phosphor (hereinafter referred to as a stimulable phosphor sheet) The stimulable phosphor sheet, on which the radiation image has been stored, is then exposed to stimulating rays, such as a laser beam, which cause it to emit light in proportion to the amount of energy stored thereon during its exposure to the radiation. The light emitted by the stimulable phosphor sheet, upon stimulation thereof, is photoelectrically detected and converted into an electric image signal. The image signal is then processed and used for the reproduction of the radiation image of the object as a visible image on a recording material.

As one of techniques for photoelectrically detecting the light emitted by a stimulable phosphor sheet, a technique for detecting light emitted from front and back surfaces of a stimulable phosphor sheet and thereby detecting two image signals from the opposite surfaces of the stimulable phosphor sheet has heretofore been known. With the technique for detecting light emitted from front and back surfaces of a stimulable phosphor sheet and thereby detecting two image signals from the opposite surfaces of the stimulable phosphor sheet, for example, a radiation image storage panel is employed, which comprises a sheet-shaped transparent substrate (such as transparent film having a thickness falling within the range of 100 μm to 500 μm) and a sheet-shaped stimulable phosphor layer overlaid on the front surface side of the transparent substrate. Radiation is irradiated to the radiation image storage panel from its stimulable phosphor layer side, and radiation image information is stored on the stimulable phosphor layer of the radiation image storage panel. Thereafter, irradiation of stimulating rays is performed from the stimulable phosphor layer side of the radiation image storage panel. When the radiation image storage panel is exposed to the stimulating rays, light is emitted from each of the front surface side (i.e., the stimulable phosphor layer side) of the radiation image storage panel and the back surface side (i.e., the transparent substrate side) of the radiation image storage panel. The light emitted from the front surface side of the radiation image storage panel and the light emitted from the back surface side of the radiation image storage panel are respectively detected with photoelectric read-out means, which is located on the front surface side of the radiation image storage panel, and photoelectric read-out means, which is located on the back surface side of the radiation image storage panel. The technique for detecting light emitted from front and back surfaces of a stimulable phosphor sheet and thereby detecting two image signals from the opposite surfaces of the stimulable phosphor sheet is disclosed in, for example, U.S. Pat. No. 4,346,295. In cases where the technique for detecting light emitted from front and back surfaces of a stimulable phosphor sheet and thereby detecting two image signals from the opposite surfaces of the stimulable phosphor sheet is utilized, an addition process can be performed on the image signal components of the two image signals having been detected from the opposite surfaces of the stimulable phosphor sheet, which image signal components represent corresponding pixels on the front and back surfaces of the stimulable phosphor sheet. In this manner, the light collecting efficiency can be enhanced. Further, since noise components are uniformized, the signal-to-noise ratio of the obtained radiation image can be enhanced.

Also, in the radiation image recording and reproducing systems described above, by way of example, the radiation image storage panel is accommodated in a cassette having a flat plate-like shape, and an image recording operation is performed on the radiation image storage panel having been accommodated in the cassette. In cases where a radiation image is to be read out from the radiation image storage panel, on which the radiation image has been stored, the cassette accommodating the radiation image storage panel is fitted into an automatic read-out apparatus. In the automatic read-out apparatus, a cover member of the cassette is opened automatically, and the radiation image storage panel is taken out from the cassette and subjected to an image read-out operation.

However, in cases where the radiation image storage panel, which comprises the transparent substrate and the stimulable phosphor layer overlaid on the front surface side of the transparent substrate, is utilized, since the substrate is transparent, the front surface and the back surface of the radiation image storage panel cannot be easily discriminated from each other. For example, in cases where the radiation image storage panel is to be accommodated in the cassette, the radiation image storage panel should be accommodated such that the front surface side of the radiation image storage panel stands facing the front side of the cassette (i.e., the cassette side facing a radiation source at the time of the image recording operation). However, since the front surface and the back surface of the radiation image storage panel cannot be easily discriminated from each other, the problems often occurs in that the front surface and the back surface of the radiation image storage panel are reversed, and the radiation image storage panel is accommodated incorrectly in the cassette with the back surface of the radiation image storage panel facing the front side of the cassette.

Also, the read-out apparatus described above has been set on the assumption that the radiation image storage panel has been accommodated correctly in the cassette with the front surface side of the radiation image storage panel facing the front side of the cassette. Specifically, the read-out apparatus described above has been set such that the irradiation of the stimulating rays is performed from the front surface side of the radiation image storage panel, i.e. the stimulable phosphor layer side of the radiation image storage panel. Therefore, if the radiation image storage panel is accommodated incorrectly in the cassette with the front surface and the back surface of the radiation image storage panel being reversed, when the radiation image storage panel is taken out from the cassette and subjected to the image read-out operation in the read-out apparatus, the irradiation of the stimulating rays will be performed from the transparent substrate side of the radiation image storage panel. In such cases, the irradiation of the stimulating rays is performed via the transparent substrate of the radiation image storage panel. Therefore, the problems occur in that the radiation image cannot always be read out accurately, and sharpness of an image obtained from the image read-out operation becomes markedly low.

### SUMMARY OF THE INVENTION

The primary object of the present invention is to provide a radiation image storage panel comprising a transparent substrate and a stimulable phosphor layer overlaid on the transparent substrate, wherein front and back surfaces of the radiation image storage panel are capable of being clearly discriminated from each other, and problems are capable of being prevented from occurring in that the radiation image storage panel is accommodated incorrectly in a cassette with the front and back surfaces of the radiation image storage panel being reversed.

Another object of the present invention is to provide a cassette for accommodating the radiation image storage panel.

The present invention provides a first radiation image storage panel having a rectangular shape, comprising a transparent substrate and a stimulable phosphor layer overlaid on a front surface side of the transparent substrate,

wherein the shape of the radiation image storage panel is asymmetric with respect to a center axis of the radiation image storage panel, which center axis extends in an antero-posterior direction of the radiation image storage panel.

In the first radiation image storage panel in accordance with the present invention, a shape of one corner area, which is among four corner areas of the radiation image storage panel, may be different from shapes of the other three corner areas. Alternatively, shapes of two corner areas, which are among four corner areas of the radiation image storage panel and which are located on one of two diagonal lines, may be identical with each other and may be different from shapes of the other two corner areas, which are located on the other diagonal line. As another alternative, one of a cutaway region, a projecting region, and a hole may be formed only at one corner area, which is among four corner areas of the radiation image storage panel, or in the vicinity of the one corner area. As a further alternative, one of a cutaway region, a projecting region, and a hole may be formed only at each of two corner areas, which are among four corner areas of the radiation image storage panel and which are located on one of two diagonal lines, or in the vicinity of each of the two corner areas.

The present invention also provides a second radiation image storage panel having a rectangular shape, comprising a transparent substrate and a stimulable phosphor layer overlaid on a front surface side of the transparent substrate,

wherein a colored region is formed on only either one of a front surface and a back surface of the radiation image storage panel.

The present invention further provides a third radiation image storage panel having a rectangular shape, comprising a transparent substrate and a stimulable phosphor layer overlaid on a front surface side of the transparent substrate,

wherein a colored region is formed on each of a front surface and a back surface of the radiation image storage panel, and

the colored region formed on the front surface of the radiation image storage panel and the colored region formed on the back surface of the radiation image storage panel differ from each other in position, shape, and/or color.

In each of the second and third radiation image storage panels in accordance with the present invention, the colored region, which is formed on the front surface of the radiation image storage panel, should preferably have a color other than colors, which are capable of absorbing stimulating rays irradiated to the radiation image storage panel and light emitted from the radiation image storage panel when the radiation image storage panel is exposed to the stimulating rays.

Also, in each of the second and third radiation image storage panels in accordance with the present invention, the colored region, which is formed on the back surface of the radiation image storage panel, should preferably have a color other than colors, which are capable of absorbing light emitted from the radiation image storage panel when the radiation image storage panel is exposed to stimulating rays.

The present invention still further provides a fourth radiation image storage panel having a rectangular shape, comprising a transparent substrate and a stimulable phosphor layer overlaid on a front surface side of the transparent substrate,

wherein the radiation image storage panel is provided with a specific shape region which acts such that a shape on a front surface of the radiation image storage panel and a shape on a back surface of the radiation image storage panel differ from each other.

The present invention also provides a first cassette, comprising an accommodating section for accommodating the first radiation image storage panel in accordance with the present invention,

wherein the accommodating section has a shape such that, due to the asymmetric shape of the radiation image storage panel, the radiation image storage panel is prevented from being accommodated in the accommodating section with a front surface and a back surface of the radiation image storage panel being reversed.

The present invention further provides a second cassette, comprising an accommodating section for accommodating the fourth radiation image storage panel in accordance with the present invention,

wherein the accommodating section has a shape such that, due to the specific shape region of the radiation image storage panel, the radiation image storage panel is prevented from being accommodated in the accommodating section with the front surface and the back surface of the radiation image storage panel being reversed.

The present invention still further provides a third cassette, comprising an accommodating section for accommodating a radiation image storage panel, which radiation image storage panel comprises a transparent substrate and a stimulable phosphor layer over laid on a front surface side of the transparent substrate,

wherein the cassette is separated into a cassette main body and a cassette sub-body,

the radiation image storage panel is secured to the cassette sub-body, and

the shape of the cassette sub-body, which shape is taken with respect to the radiation image storage panel, varies between when the radiation image storage panel is located with a front surface of the radiation image storage panel facing up and when the radiation image storage panel is located with a back surface of the radiation image storage panel facing up.

With the first radiation image storage panel in accordance with the present invention, the shape of the radiation image storage panel is asymmetric with respect to the center axis of the radiation image storage panel, which center axis extends in the antero-posterior direction of the radiation image storage panel. Therefore, the shape of the radiation image storage panel, as viewed from above the front surface of the radiation image storage panel, and the shape of the radiation image storage panel, as viewed from above the back surface of the radiation image storage panel, vary from each other. Accordingly, in cases where the shape of the radiation image storage panel, as viewed from above the front surface of the radiation image storage panel, has been recognized previously, the front surface and the back surface of the radiation image storage panel are capable of being easily discriminated from each other by merely seeing the shape of the radiation image storage panel. As a result, the problems are capable of being prevented from occurring in that, for example, the radiation image storage panel provided with the transparent substrate is accommodated incorrectly in a cassette with the front and back surfaces of the radiation image storage panel being reversed.

With the second radiation image storage panel in accordance with the present invention, the colored region is formed on only either one of the front surface and the back surface of the radiation image storage panel. Therefore, in cases where it has been recognized previously on which surface the colored region is formed, the front surface and the back surface of the radiation image storage panel are capable of being easily discriminated from each other by merely seeing the presence or absence of the colored region. Accordingly, the problems are capable of being prevented from occurring in that, for example, the radiation image storage panel provided with the transparent substrate is accommodated incorrectly in a cassette with the front and back surfaces of the radiation image storage panel being reversed.

With the third radiation image storage panel in accordance with the present invention, the colored region is formed on each of the front surface and the back surface of the radiation image storage panel, and the colored region formed on the front surface of the radiation image storage panel and the colored region formed on the back surface of the radiation image storage panel differ from each other in position, shape, and/or color. Therefore, in cases where the position, the shape, and/or the color of the colored region formed on the front surface or the back surface of the radiation image storage panel has been recognized previously, the front surface and the back surface of the radiation image storage panel are capable of being easily discriminated from each other by merely seeing the position, the shape, and/or the color of the colored region. Accordingly, the problems are capable of being prevented from occurring in that, for example, the radiation image storage panel provided with the transparent substrate is accommodated incorrectly in a cassette with the front and back surfaces of the radiation image storage panel being reversed.

With the fourth radiation image storage panel in accordance with the present invention, the radiation image storage panel is provided with the specific shape region which acts such that the shape on the front surface of the radiation image storage panel and the shape on the back surface of the radiation image storage panel differ from each other. Therefore, for example, in cases where it has been recognized previously at which position the specific shape region is located when the radiation image storage panel is viewed from above the front surface, the front surface and the back surface of the radiation image storage panel are capable of being easily discriminated from each other by merely seeing the position of the specific shape region. Accordingly, the problems are capable of being prevented from occurring in that, for example, the radiation image storage panel provided with the transparent substrate is accommodated incorrectly in a cassette with the front and back surfaces of the radiation image storage panel being reversed.

With the first cassette in accordance with the present invention, comprising the accommodating section for accommodating the first radiation image storage panel in accordance with the present invention, which has the asymmetric shape, the accommodating section has the shape such that, due to the asymmetric shape of the radiation image storage panel, the radiation image storage panel is prevented from being accommodated in the accommodating section with the front surface and the back surface of the radiation image storage panel being reversed. Therefore, in cases where the radiation image storage panel is to be accommodated in the cassette, particular attention need not be paid, and the radiation image storage panel cannot be accommodated in the cassette with the front and back surfaces of the radiation image storage panel being reversed. Accordingly, the problems are capable of being prevented reliably from occurring in that the radiation image storage panel is accommodated incorrectly in the cassette with the front and back surfaces of the radiation image storage panel being reversed.

With the second cassette in accordance with the present invention, comprising the accommodating section for accommodating the fourth radiation image storage panel in accordance with the present invention, which has the specific shape region, the accommodating section has the shape such that, due to the specific shape region of the radiation image storage panel, the radiation image storage panel is prevented from being accommodated in the accommodating section with the front surface and the back surface of the radiation image storage panel being reversed. Therefore, in cases where the radiation image storage panel is to be accommodated in the cassette, particular attention need not be paid, and the radiation image storage panel cannot be accommodated in the cassette with the front and back surfaces of the radiation image storage panel being reversed. Accordingly, the problems are capable of being prevented reliably from occurring in that the radiation image storage panel is accommodated incorrectly in the cassette with the front and back surfaces of the radiation image storage panel being reversed.

With the third cassette in accordance with the present invention, the cassette is separated into the cassette main body and the cassette sub-body, the radiation image storage panel is secured to the cassette sub-body, and the shape of the cassette sub-body, which shape is taken with respect to the radiation image storage panel, varies between when the radiation image storage panel is located with the front surface of the radiation image storage panel facing up and when the radiation image storage panel is located with the back surface of the radiation image storage panel facing up. Therefore, for example, the cassette maybe formed such that, when the radiation image storage panel is accommodated in the panel accommodating section of the cassette main body with the front surface of the radiation image storage panel facing up, the shape of the cassette main body and the shape of the cassette sub-body coincide with each other. In such cases, if the radiation image storage panel is introduced into the cassette main body with the back surface of the radiation image storage panel facing up, the shape of the cassette main body and the shape of the cassette sub-body will not coincide with each other. Accordingly, the problems are capable of being prevented from occurring in that the radiation image storage panel is accommodated incorrectly in the cassette with the front and back surfaces of the radiation image storage panel being reversed.

### BRIEF DESCRIPTION OF THE DRAWINGS

FIG. 1 is a perspective view showing a constitution of a radiation image storage panel,

FIG. 2 is a schematic view showing an example of a read-out apparatus for performing an operation for detecting light emitted from front and back surfaces of the radiation image storage panel and thereby detecting two image signals from the opposite surfaces of the radiation image storage panel,

FIGS. 3A, 3B, 3C, 3D, and 3E are front views showing embodiments of the radiation image storage panel in accordance with the present invention,

FIGS. 4A, 4B, 4C, 4D, and 4E are front views showing different embodiments of the radiation image storage panel in accordance with the present invention,

FIGS. 5A and 5B are front views showing further different embodiments of the radiation image storage panel in accordance with the present invention,

FIG. 6A is a front view showing a still further different embodiment of the radiation image storage panel in accordance with the present invention,

FIG. 6B is a side view showing the embodiment of the radiation image storage panel shown in FIG. 6A,

FIG. 7 is a perspective view showing an embodiment of the cassette in accordance with the present invention,

FIG. 8 is a sectional view taken on line VIII-VIII of FIG. 7,

FIG. 9 is a perspective view showing a different embodiment of the cassette in accordance with the present invention,

FIG. 10 is a sectional view taken on line X-X of FIG. 9,

FIG. 11 is a perspective view showing a further different embodiment of the cassette in accordance with the present invention,

FIG. 12 is a partially cutaway side view showing the cassette of FIG. 11,

FIG. 13 is a perspective view showing a still further different embodiment of the cassette in accordance with the present invention, and

FIG. 14 is a plan view showing a state in which a radiation image storage panel has been introduced to an intermediate point in the cassette of FIG. 13.

### DESCRIPTION OF THE PREFERRED EMBODIMENTS

The present invention will hereinbelow be described in further detail with reference to the accompanying drawings.

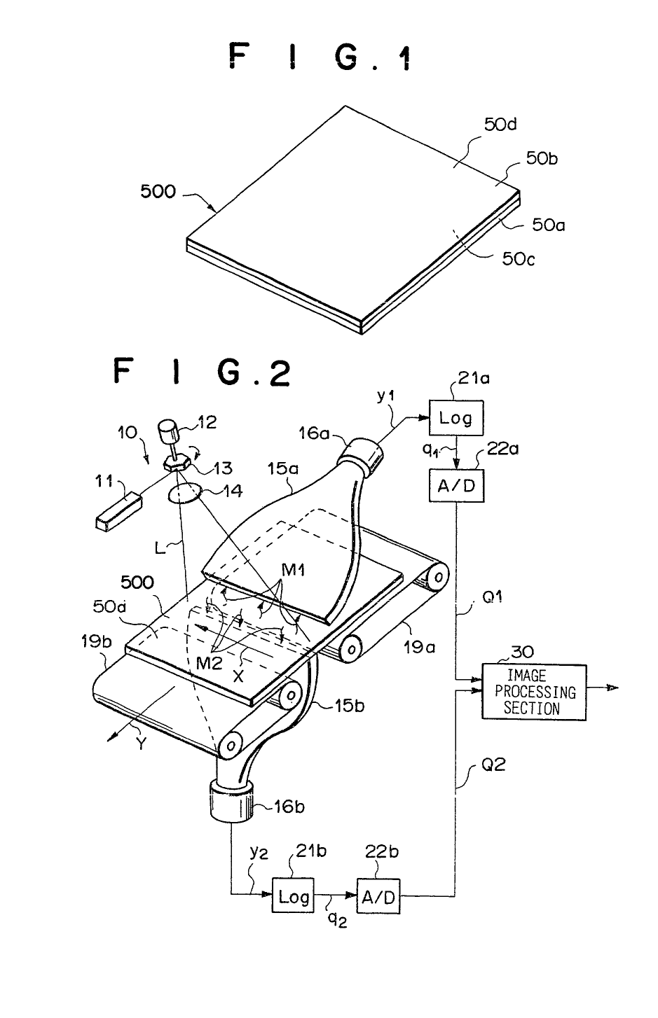

Firstly, a radiation image storage panel, which comprises a transparent substrate and a stimulable phosphor layer overlaid on the transparent substrate, will be described hereinbelow with reference to FIG. 1. Also, how an operation for detecting light emitted from front and back surfaces of the radiation image storage panel and thereby detecting two image signals from the opposite surfaces of the radiation image storage panel is performed will be described with reference to FIG. 2.

As illustrated in FIG. 1, a radiation image storage panel 500 comprises a sheet-shaped, colorless, transparent substrate 50a, which transmits light emitted by a stimulable phosphor layer, and a sheet-shaped stimulable phosphor layer (a BaFBrI:Eu layer) 50b overlaid on a front surface side of the transparent substrate 50a. The surface of the radiation image storage panel 500 on the side of the transparent substrate 50a is taken as a back surface 50c of the radiation image storage panel 500. The surface of the radiation image storage panel 500 on the side of the stimulable phosphor layer 50b is taken as a front surface 50d of the radiation image storage panel 500. Ordinarily, the transparent substrate 50a is formed from a thin, soft, transparent plastic film having flexibility and having a thickness falling within the range of 100 μm to 500 μm. Alternatively, the transparent substrate 50a may be formed from a hard, transparent plastic sheet having rigidity. The radiation image storage panel 500 has a rectangular shape (a square shape or an oblong shape) , as viewed from above the front surface 50d. Also, though not shown, a transparent protective layer having a thickness falling within the range of 2 μm to 50 μm is overlaid on the surface of the stimulable phosphor layer 50b.

FIG. 2 is a schematic view showing an example of a radiation image read-out apparatus for performing an image read-out operation, in which a radiation image having been stored on the radiation image storage panel 500 is read out from the radiation image storage panel 500. With the radiation image read-out apparatus illustrated in FIG. 2, the radiation image, which has been stored on the stimulable phosphor layer 50b of the radiation image storage panel 500 shown in FIG. 1, is read out from both the front surface 50d and the back surface 50c of the radiation image storage panel 500.

In the radiation image read-out apparatus shown in FIG. 2, the radiation image storage panel 500, on which the radiation image information has been stored, is set at a predetermined position on an endless belt 19a such that the front surface 50d of the radiation image storage panel 500 stands facing up. The radiation image storage panel 500 is conveyed in the direction (sub-scanning direction), which is indicated by the arrow Y, by endless belts 19a and 19b, which are driven by motors (not shown).

A laser beam L, which serves as stimulating rays, is produced by a laser beam source 11. The laser beam L is reflected and deflected by a rotating polygon mirror 13, which is being quickly rotated by a motor 12 in the direction indicated by the arrow. The laser beam L is then converged by a scanning lens 14 onto the front surface 50d of the radiation image storage panel 500 and is caused to scan the front surface 50d at uniform speed. The front surface 50d of the radiation image storage panel 500 is thus scanned with the laser beam L in the main scanning direction indicated by the arrow X. By the main scanning with the laser beam L and the sub-scanning of the radiation image storage panel 500, the entire area of the radiation image storage panel 500 is exposed to the laser beam L.

The laser beam L impinging upon the radiation image storage panel 500 causes the stimulable phosphor layer 50b of the radiation image storage panel 500 to emit light in proportion to the amount of energy stored thereon during its exposure to radiation. Light M1 in accordance with the stored radiation image information is emitted from the front surface 50d of the radiation image storage panel 500. Also, Light M2 in accordance with the stored radiation image information is emitted from the back surface 50c of the radiation image storage panel 500.

The light M1, which has been emitted from the front surface 50d of the radiation image storage panel 500, is guided by a light guide member 15a, which is located close to the front surface 50d, into a photomultiplier 16a and is photoelectrically detected by the photomultiplier 16a. Also, the light M2, which has been emitted from the back surface 50c of the radiation image storage panel 500, is guided by a light guide member 15b, which is located close to the back surface 50c, into a photomultiplier 16b and is photoelectrically detected by the photomultiplier 16b. Each of the light guide member 15a and the light guide member 15b is made from a light guiding material, such as an acrylic plate. Each of the light guide member 15a and the light guide member 15b has a linear light input face, which is positioned to extend along the main scanning line on the radiation image storage panel 500, and a ring-shaped light output face, which is positioned so that it is in close contact with a light receiving face of the corresponding photomultiplier 16a or 16b. The emitted light M1, which has entered the light guide member 15a from its light input face, is guided through repeated total reflection inside of the light guide member 15a, emanates from the light output face, and is received by the photomultiplier 16a. In this manner, the amount of the emitted light M1, which amount represents the stored radiation image information, is converted into an analog image signal y1 by the photomultiplier 16a. In the same manner as that described above, the emitted light M2, which has entered the light guide member 15b from its light input face, is guided through repeated total reflection inside of the light guide member 15b, emanates from the light output face, and is received by the photomultiplier 16b. In this manner, the amount of the emitted light M2, which amount represents the stored radiation image information, is converted into an analog image signal y2 by the photomultiplier 16b.

The analog image signal y1 generated by the photomultiplier 16a is logarithmically amplified by a logarithmic amplifier 21a and is converted into a logarithmic image signal q1. The logarithmic image signal q1 having been obtained from the logarithmic amplification is fed into an analog-to-digital conversion circuit 22a. The analog-to-digital converter 22a samples the logarithmic image signal q1 with a predetermined sampling period T, and the sampled signal is converted into a digital image signal Q1. In the same manner as that described above, the analog image signal y2 generated by the photomultiplier 16b is logarithmically amplified by a logarithmic amplifier 21b and is converted into a logarithmic image signal q2. The logarithmic image signal q2 having been obtained from the logarithmic amplification is fed into an analog-to-digital conversion circuit 22b. The analog-to-digital converter 22b samples the logarithmic image signal q2 with a predetermined sampling period T, and the sampled signal is converted into a digital image signal Q2. The digital image signal O1 and the digital image signal Q2 are fed into an image processing section 30.

In the image processing section 30, the image signal components of the digital image signal Q1 and the digital image signal Q2, which image signal components represent corresponding pixels on the front surface side and the back surface side of the radiation image storage panel 500, are weighted and added to each other in a predetermined addition ratio. An image signal Q, which has been obtained from the weighted addition, is then subjected to various kinds of signal processing, such as gradation processing and processing in the frequency domain. A processed image signal having thus been obtained is fed into an external image reproducing apparatus, or the like. The addition ratio of the digital image signal Q1, which has been detected from the front surface side of the radiation image storage panel 500, to the digital image signal Q2, which has been detected from the back surface side of the radiation image storage panel 500, is set appropriately such that noise may be suppressed.

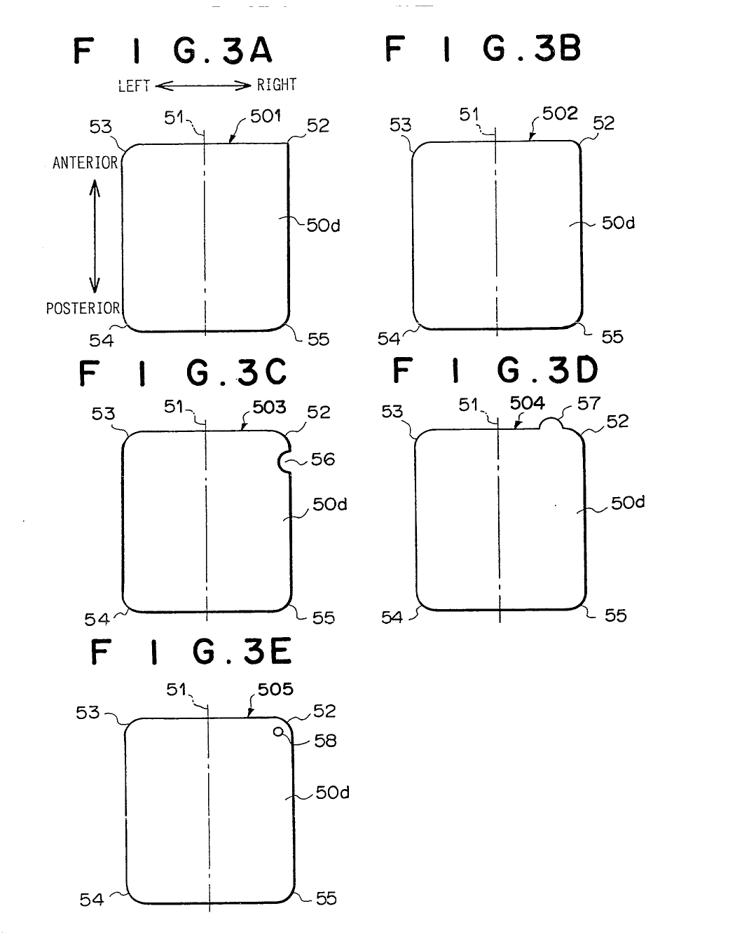

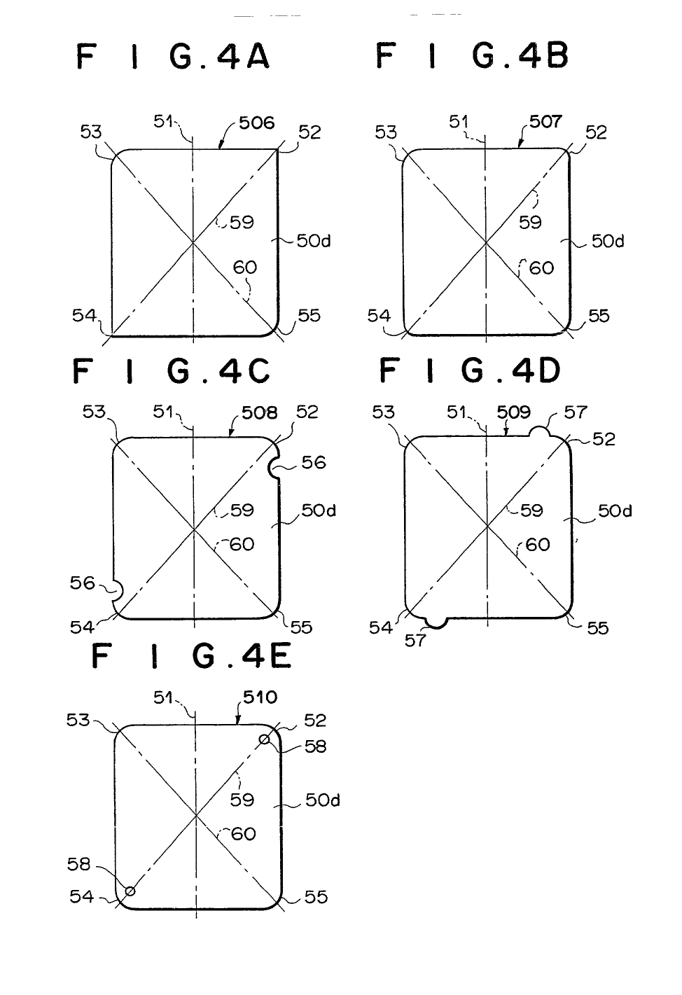

Embodiments of the radiation image storage panel in accordance with the present invention and embodiments of the cassette in accordance with the present invention will be described hereinbelow with reference to FIGS. 3A, 3B, 3C, 3D, and 3E through FIG. 14. Basically, the embodiments of the radiation image storage panel described below has the same constitution as that of the radiation image storage panel 500 illustrated in Figure FIGS. 3A, 3B, 3C, 3D, and 3E and FIGS. 4A, 4B, 4C, 4D, and 4E are front views (i.e., the views taken from above the front surfaces 50d, 50d, . . . of the respective radiation image storage panels) showing the embodiments of the radiation image storage panel in accordance with the present invention, which has an asymmetric shape with respect to a center axis 51 extending in an antero-posterior direction of the radiation image storage panel. In the embodiments of the radiation image storage panel described below, the direction, in which the radiation image storage panel is inserted into the cassette and taken out from the cassette, is taken as the antero-posterior direction of the radiation image storage panel. However, the antero-posterior direction of the radiation image storage panel may be set arbitrarily with respect to the radiation image storage panel.

In each of a radiation image storage panel 501 shown in FIG. 3A and a radiation image storage panel 502 shown in FIG. 3B, the shape of an anterior right corner area 52, which is among the four corner areas, is different from the shapes of the other three corner areas, i.e. an anterior left corner area 53, a posterior left corner area 54, and a posterior right corner area 55. The term “different shape” as used herein means both the cases where the kind of the shape is different and the cases where the kind of the shape is identical and the size of the shape is different (e.g., the cases where the kind of the shape is a circular arc and the radius of the circular arc is different). FIG. 3A shows the cases where the kind of the shape of the anterior right corner area 52 is different from the kinds of the shapes of the other three corner areas 53, 54, and 55. Specifically, in FIG. 3A, the anterior right corner area 52 has a right-angled shape, and the other three corner areas 53, 54, and 55 have circular arc shapes. FIG. 3B shows the cases where the kind of the shape of the anterior right corner area 52 is identical with the kinds of the shapes of the other three corner areas 53, 54, and 55, and the size of the shape of the anterior right corner area 52 is different from the sizes of the shapes of the other three corner areas 53, 54, and 55. Specifically, in FIG. 3B, the anterior right corner area 52 has a circular arc shape with a small radius, and the other three corner areas 53, 54, and 55 have circular arc shapes with a radius larger than the radius of the anterior right corner area 52. In each of the radiation image storage panel 501 shown in FIG. 3A and the radiation image storage panel 502 shown in FIG. 3B, the other three corner areas 53, 54, and 55 have the circular arc shapes with the same radius.

As described above, with each of the radiation image storage panel 501 shown in FIG. 3A and the radiation image storage panel 502 shown in FIG. 3B, the shape of the anterior right corner area 52 is different from the shapes of the other three corner areas 53, 54, and 55. In such cases, it may be recognized previously that, when the radiation image storage panel 501 or 502 is seen from above the front surface 50d, the corner area 52 is located at the anterior right position or the posterior left position. If the front surface 50d and the back surface 50c of the radiation image storage panel 501 or 502 are reversed, the corner area 52 will be located at, for example, the posterior right position or the anterior left position. Therefore, the front surface 50d and the back surface 50c of the radiation image storage panel 501 or 502 are capable of being easily discriminated from each other. Also, in accordance with whether the corner area 52 is located at the anterior right position or the posterior left position, it is capable of being found that the front surface 50d stands facing up, and the anterior side and the posterior side of the radiation image storage panel 501 or 502 are capable of being discriminated from each other.

In each of a radiation image storage panel 503 shown in FIG. 3C, a radiation image storage panel 504 shown in FIG. 3D, and a radiation image storage panel 505 shown in FIG. 3E, a cutaway region, a projecting region, or a hole is formed only at the anterior right corner area 52, which is among the four corner areas, or in the vicinity of the anterior right corner area 52. In the cases of the radiation image storage panel 503 shown in FIG. 3C, a semicircular cutaway region 56 is formed in the vicinity of the anterior right corner area 52. In the cases of the radiation image storage panel 504 shown in FIG. 3D, a semicircular projecting region 57 is formed in the vicinity of the anterior right corner area 52. In the cases of the radiation image storage panel 505 shown in FIG. 3E, a circular hole 58 is formed in the vicinity of the anterior right corner area 52.

As described above, with each of the radiation image storage panel 503 shown in FIG. 3C, the radiation image storage panel 504 shown in FIG. 3D, and the radiation image storage panel 505 shown in FIG. 3E, the cutaway region 56, the projecting region 57, or the hole 58 is formed only at the anterior right corner area 52 or in the vicinity of the anterior right corner area 52. In such cases, it may be recognized previously that, when the radiation image storage panel 503, 504, or 505 is seen from above the front surface 50d, the cutaway region 56, the projecting region 57, or the hole 58 is located at the anterior right position or the posterior left position. If the front surface 50d and the back surface 50c of the radiation image storage panel 503, 504, or 505 are reversed, the cut away region 56, the projecting 25 region 57, or the hole 58 will be located at, for example, the posterior right position or the anterior left position. Therefore, the front surface 50d and the back surface 50c of the radiation image storage panel 503, 504, or 505 are capable of being easily discriminated from each other. Also, in accordance with whether the cutaway region 56, the projecting region 57, or the hole 58 is located at the anterior right position or the posterior left position, it is capable of being found that the front surface 50d stands facing up, and the anterior side and the posterior side of the radiation image storage panel 503, 504, or 505 are capable of being discriminated from each other.

In each of a radiation image storage panel 506 shown in FIG. 4A and a radiation image storage panel 507 shown in FIG. 4B, the shapes of the two corner areas 52 and 54, which are among the four corner areas of the radiation image storage panel and which are located on one diagonal line 59, are identical with each other and are different from the shapes of the other two corner areas 53 and 55, which are located on the other diagonal line 60. FIG. 4A shows the cases where the kinds of the shapes of the two corner areas 52 and 54, which are located on the diagonal line 59, are different from the kinds of the shapes of the other two corner areas 53 and 55, which are located on the other diagonal line 60. Specifically, in FIG. 4A, the corner areas 52 and 54, which are located on the diagonal line 59, have right-angled shapes, and the corner areas 53, and 55, which are located on the diagonal line 60, have circular arc shapes with the same radius. FIG. 4B shows the cases where the kinds of the shapes of the two corner areas 52 and 54, which are located on the diagonal line 59, are identical with the kinds of the shapes of the other two corner areas 53 and 55, which are located on the diagonal line 60, and the sizes of the shapes of the two corner areas 52 and 54 are different from the sizes of the shapes of the other two corner areas 53 and 55. Specifically, in FIG. 4B, the corner areas 52 and 54, which are located on the diagonal line 59, have circular arc shapes with a small radius, which are identical with each other, and the corner areas 53 and 55, which are located on the diagonal line 60, have circular arc shapes, which are identical with each other and has a radius larger than the radius of the corner areas 52 and 54.

As described above, with each of the radiation image storage panel 506 shown in FIG. 4A and the radiation image storage panel 507 shown in FIG. 4B, the shapes of the two corner areas 52 and 54, which are among the four corner areas of the radiation image storage panel and which are located on one diagonal line 59, are identical with each other and are different from the shapes of the other two corner areas 53 and 55, which are located on the other diagonal line 60. In such cases, it may be recognized previously that, when the radiation image storage panel 506 or 507 is seen from above the front surface 50d, the corner areas 52 and 54, which are located on one diagonal line 59 and which have the right-angled shapes or the circular arc shapes with a small radius, are located at the anterior right position and the posterior left position. If the front surface 50d and the back surface 50c of the radiation image storage panel 506 or 507 are reversed, the corner areas 52 and 54, which have the right-angled shapes or the circular arc shapes with a small radius, will be located at the posterior right position and the anterior left position. Therefore, the front surface 50d and the back surface 50c of the radiation image storage panel 506 or 507 are capable of being easily discriminated from each other.

In each of a radiation image storage panel 508 shown in FIG. 4C, a radiation image storage panel 509 shown in FIG. 4D, and a radiation image storage panel 510 shown in FIG. 4E, a cutaway region, a projecting region, or a hole is formed only at each of the corner areas 52 and 54, which are located on one diagonal line 59, or in the vicinity of each of the corner areas 52 and 54. In the cases of the radiation image storage panel 508 shown in FIG. 4C, semicircular cutaway regions 56, 56, which have the shapes identical with each other, are formed in the vicinity of the two corner areas 52 and 54, which are located on one diagonal line 59, and at the positions on the radiation image storage panel 508, which positions are rotationally symmetric with each other. In the cases of the radiation image storage panel 509 shown in FIG. 4D, semicircular projecting regions 57, 57, which have the shapes identical with each other, are formed in the vicinity of the two corner areas 52 and 54, which are located on one diagonal line 59, and at the positions on the radiation image storage panel 509, which positions are rotationally symmetric with each other. In the cases of the radiation image storage panel 510 shown in FIG. 4E, circular holes 58, 58, which have the shapes identical with each other, are formed in the vicinity of the two corner areas 52 and 54, which are located on one diagonal line 59, and at the positions on the radiation image storage panel 510, which positions are rotationally symmetric with each other.

As described above, with each of the radiation image storage panel 508 shown in FIG. 4C, the radiation image storage panel 509 shown in FIG. 4D, and the radiation image storage panel 510 shown in FIG. 4E, the cutaway regions 56, 56, the projecting regions 57, 57, or the holes 58, 58 are formed only at the corner areas 52 and 54, which are located on one diagonal line 59, or in the vicinity of the corner areas 52 and 54. In such cases, it may be recognized previously that, when the radiation image storage panel 508, 509, or 510 is seen from above the front surface 50d, the cutaway regions 56, 56, the projecting regions 57, 57, or the holes 58, 58, which are formed at the corner areas 52 and 54 located on one diagonal line 59 or are formed in the vicinity of the corner areas 52 and 54, are located at the anterior right position and the posterior left position. If the front surface 50d and the back surface 50c of the radiation image storage panel 508, 509, or 510 are reversed, the cutaway regions 56, 56, the projecting regions 57, 57, or the holes 58, 58 will be located at the posterior right position and the anterior left position. Therefore, the front surface 50d and the back surface 50c of the radiation image storage panel 508, 509, or 510 are capable of being easily discriminated from each other.

An embodiment of the radiation image storage panel in accordance with the present invention, wherein a colored region is formed on only either one of a front surface and a back surface of the radiation image storage panel, will be described hereinbelow. Also, an embodiment of the radiation image storage panel in accordance with the present invention, wherein a colored region is formed on each of a front surface and a back surface of the radiation image storage panel, and the colored region formed on the front surface of the radiation image storage panel and the colored region formed on the back surface of the radiation image storage panel differ from each other in position, shape, and/or color, will be described below.

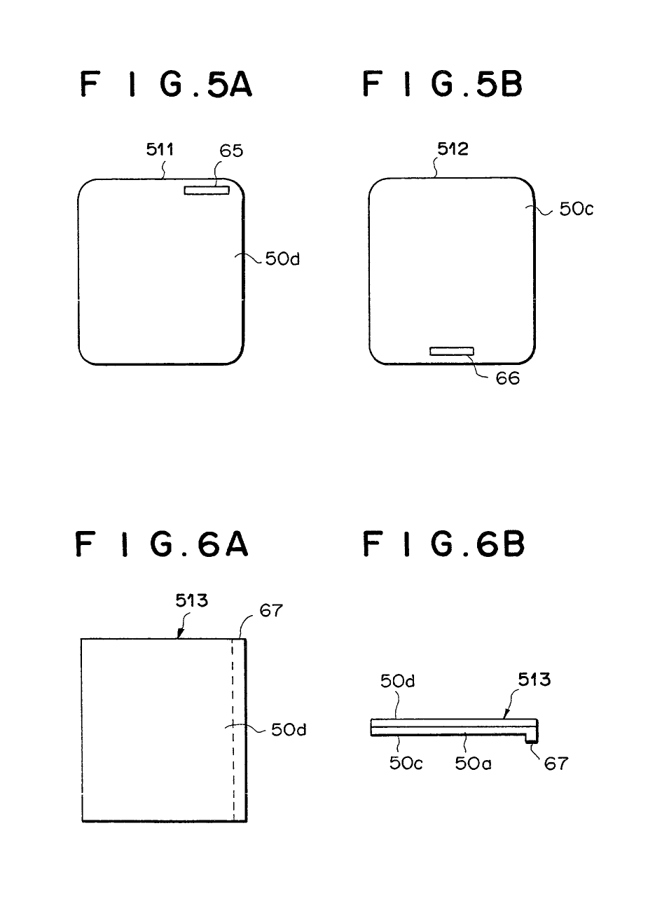

FIG. 5A is a front view (i.e., the view taken from above the front surface 50d of the radiation image storage panel) showing the embodiment of the radiation image storage panel in accordance with the present invention, in which a colored region is formed on only the front surface 50d of the radiation image storage panel. As illustrated in FIG. 5A, in a radiation image storage panel 511, a colored region 65 having a predetermined color is formed on only the front surface 50d.

The radiation image storage panel 511 has no colored region on the back surface 50c. However, as in the cases of a radiation image storage panel 512 illustrated in FIG. 5B, a colored region 66 may also be formed on the back surface 50c. In such cases, it is necessary that the colored region 65, which is formed on the front surface 50d of the radiation image storage panel 512, and the colored region 66, which is formed on the back surface 50c of the radiation image storage panel 512, differ from each other in position, shape, and/or color. For example, in cases where the colored region 65 on the front surface 50d is formed at a position in the vicinity of the peripheral edge of the anterior right corner area of the radiation image storage panel as illustrated in FIG. 5A, the colored region 66 on the back surface 50c may be formed in the vicinity of a posterior middle position on the radiation image storage panel as illustrated in FIG. 5B. No limitation is imposed upon the positions of the colored region 65 and the colored region 66. However, each of the colored region 65 and the colored region 66 should preferably be located at a position in the vicinity of the peripheral edge of the radiation image storage panel. Also, each of the colored region 65 and the colored region 66 should preferably have a predetermined color different from the color of the stimulable phosphor. Each of the colored region 65 and the colored region 66 may be formed by a mere coloring process. Alternatively, each of the colored region 65 and the colored region 66 may be formed as a colored region having a shape of a figure, a letter, or the like. Further, regardless of whether the colored region 65 is or is not formed on the front surface 50d, in cases where the colored region is formed on the back surface 50c, the colored region should preferably be formed over the entire area of the back surface 50c.

As described above, with the embodiment of the radiation image storage panel in accordance with the present invention, the colored region is formed on only either one of the front surface 50d and the back surface 50c of the radiation image storage panel. Therefore, in cases where it has been recognized previously on which surface the colored region is formed, the front surface 50d and the back surface 50c of the radiation image storage panel are capable of being easily discriminated from each other by merely seeing the presence or absence of the colored region.

Also, as described above, with the embodiment of the radiation image storage panel in accordance with the present invention, the colored region 65 and the colored region 66 are formed on both the front surface 50d and the back surface 50c of the radiation image storage panel, and the colored region 65 formed on the front surface 50d and the colored region 66 formed on the back surface 50c differ from each other in position, shape, and/or color. Therefore, in cases where the position, the shape, and/or the color of the colored region 65 formed on the front surface 50d or the colored region 66 formed on the back surface 50c has been recognized previously, the front surface 50d and the back surface 50c of the radiation image storage panel are capable of being easily discriminated from each other by merely seeing the position, the shape, and/or the color of the colored region.

The colored region 65, which is formed on the front surface 50d of the radiation image storage panel, has a color other than colors, which are capable of absorbing stimulating rays irradiated to the radiation image storage panel and light emitted from the radiation image storage panel when the radiation image storage panel is exposed to the stimulating rays. Also, the colored region 66, which is formed on the back surface 50c of the radiation image storage panel, has a color other than colors, which are capable of absorbing light emitted from the radiation image storage panel when the radiation image storage panel is exposed to stimulating rays. Specifically, for example, the colored region 65 formed on the front surface 50d may be colored with a dye, which is capable of absorbing only light having wavelengths falling within the range of 500 nm to 600 nm. Also, for example, in cases where the stimulable phosphor is BFX:Eu, the colored region 66 formed on the back surface 50c may have a color, which does not absorb light having wavelengths falling within the range of 350 nm to 450 nm. Further, the colored region 66 formed on the back surface 50c may have a blue color.

In cases where the colored region 65 and the colored region 65 have the colors described above, the stimulating rays and the light emitted by the radiation image storage panel are not absorbed by the colored region 65 formed on the front surface 50d, and the light emitted by the radiation image storage panel is not absorbed by the colored region 66 formed on the back surface 50c. Therefore, there is no risk that the read-out performance will become low due to absorption loss of the stimulating rays and the light emitted by the radiation image storage panel.

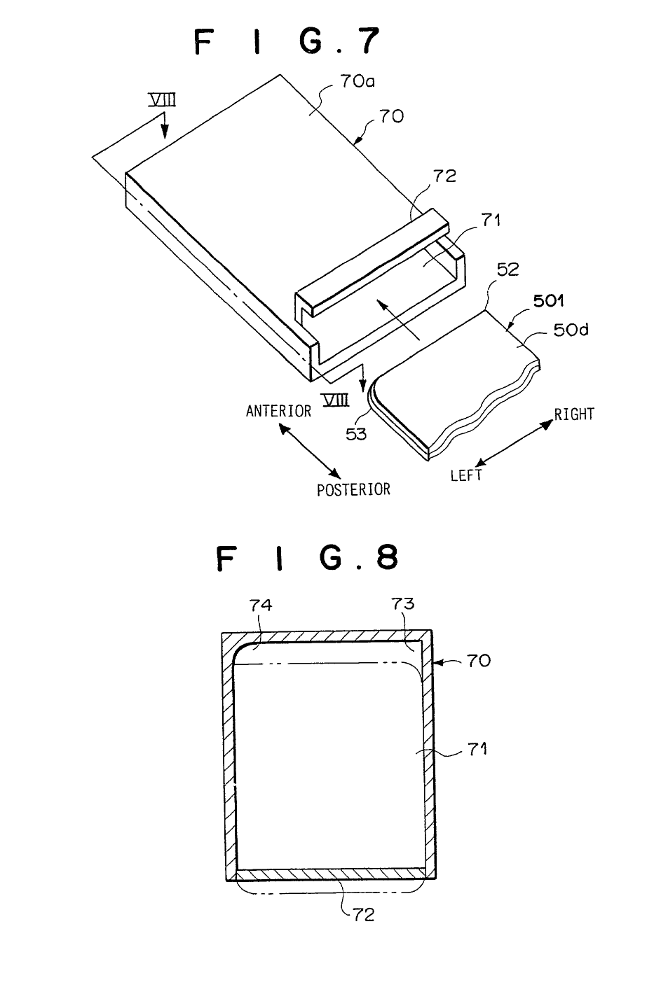

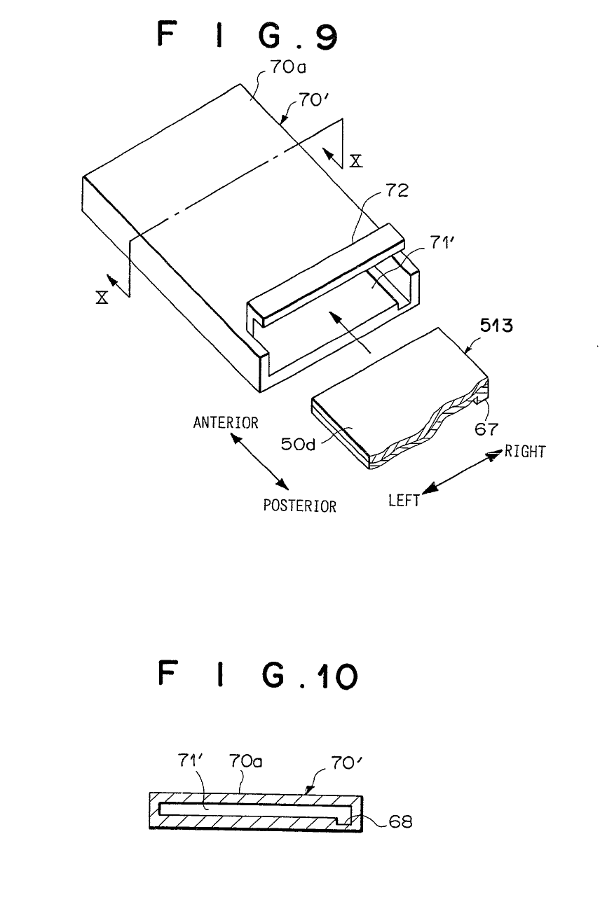

An embodiment of the radiation image storage panel in accordance with the present invention, which is provided with a specific shape region acting such that the shape on a front surface of the radiation image storage panel and the shape on a back surface of the radiation image storage panel differ from each other, will be described hereinbelow. FIG. 6A is a front view showing the embodiment of the radiation image storage panel in accordance with the present invention. FIG. 6B is a side view showing the embodiment of the radiation image storage panel shown in FIG. 6A.

In a radiation image storage panel 513 shown in FIGS. 6A and 6B, an elongated convex region 67, which protrudes downwardly from the back surface 50c, is formed as the specific shape region. The elongated convex region 67 extends along the right edge of the radiation image storage panel 513 over the entire length of the radiation image storage panel 513 from the anterior side edge to the posterior side edge. In this embodiment, the elongated convex region 67 is combined with the transparent substrate 50a into an integral body. Alternatively, the elongated convex region 67 and the transparent substrate 50a maybe formed as two independent bodies, and the elongated convex region 67 may be secured to the back surface 50c of the transparent substrate 50a. In this embodiment, the transparent substrate 50a is formed from a hard plastic material in order to impart predetermined rigidity to the elongated convex region 67. Also, when the radiation image storage panel 513 is to be accommodated in a cassette, the anterior edge side of the radiation image storage panel 513 is inserted into the cassette as will be described later. Therefore, in this embodiment, the specific shape region is formed as the elongated convex region 67 having uniform cross-sectional shape and extending along the right edge, which is one of the right and left edges of the radiation image storage panel 513 with respect to the direction of insertion into the cassette. However, no limitation is imposed upon the position, the shape, and the like, of the specific shape region. Also, in lieu of the convex region, a concave region may be formed as the specific shape region.

Embodiments of the cassette in accordance with the present invention will be described hereinbelow.

FIG. 7 is a perspective view showing an embodiment of the cassette in accordance with the present invention, which is constituted to accommodate, for example, the radiation image storage panel 501 shown in FIG. 3A having the asymmetric shape with respect to the center axis 51 extending in the antero-posterior direction of the radiation image storage panel 501. FIG. 8 is a sectional view taken on line VIII-VIII of FIG. 7.

As illustrated in FIG. 7, a cassette 70 comprises a panel accommodating section 71, which is formed within the cassette 70, and a cover member 72, which is located at one end of the cassette 70 and which is capable of being opened and closed. The radiation image storage panel 501 is inserted into and taken out from the panel accommodating section 71 in the state, in which the cover member 72 is open as illustrated in FIG. 7. As illustrated in FIG. 8, the panel accommodating section 71 has a shape such that, when the radiation image storage panel 501 is located with the front surface 50d facing a front surface 70a of the cassette 70 (i.e., the surface facing a radiation source side in the radiation image recording operation), the radiation image storage panel 501 is capable of being accommodated in the panel accommodating section 71, and such that, when the radiation image storage panel 501 is located with the front surface 50d and the back surface 50c being reversed, the radiation image storage panel 501 cannot be completely accommodated in the panel accommodating section 71. Specifically, as illustrated in FIG. 8, the shape of the panel accommodating section 71, as viewed from above the front surface 70a of the cassette 70, is set so as to coincide in whole or in part with the shape of the radiation image storage panel 501, as viewed from above the front surface 50d. In this embodiment, the shape of an anterior right corner area 73 of the panel accommodating section 71 coincides with the shape of the anterior right corner area 52 of the radiation image storage panel 501. Also, the shape of an anterior left corner area 74 of the panel accommodating section 71 coincides with the shape of the anterior left corner area 53 of the radiation image storage panel 501. More specifically, the anterior right corner area 73 has the right-angled shape, and the anterior left corner area 74 has the circular arc shape.

Therefore, when the radiation image storage panel 501 is inserted into the panel accommodating section 71 with the front surface 50d facing the front surface 70a of the cassette 70, the radiation image storage panel 501 is capable of being completely accommodated in the panel accommodating section 71. However, as indicated by the double-dot chained line in FIG. 8, when the radiation image storage panel 501 is inserted into the panel accommodating section 71 with the front surface 50d and the back surface 50c being reversed, the anterior edge of the radiation image storage panel 501 cannot be inserted beyond an intermediate point in the panel accommodating section 71, and the radiation image storage panel 501 cannot be completely accommodated in the panel accommodating section 71. Accordingly, the problems are capable of being prevented from occurring in that the radiation image storage panel 501 is accommodated in the cassette 70 with the front surface 50d and the back surface 50c being reversed.

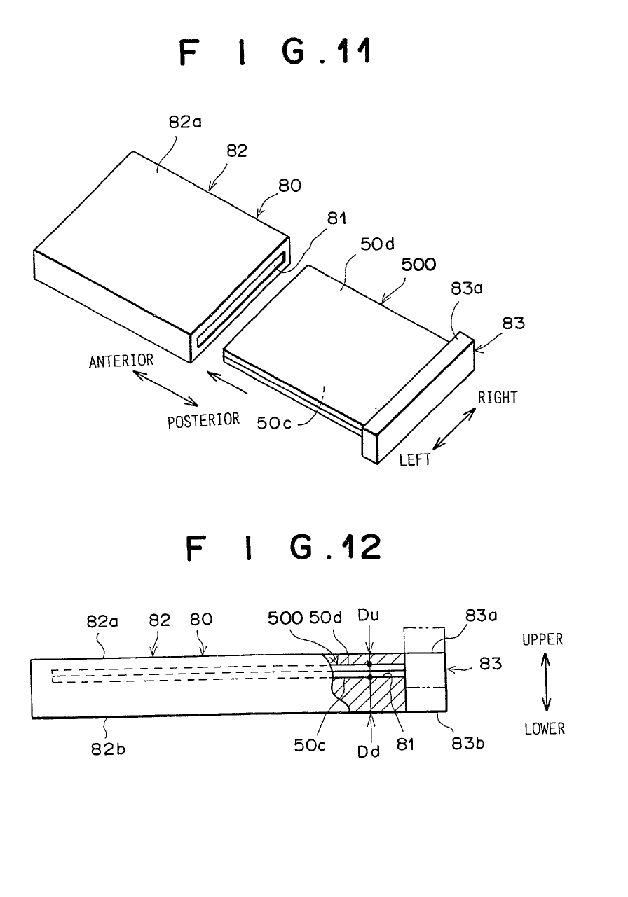

FIG. 9 is a perspective view showing a different embodiment of the cassette in accordance with the present invention, which is constituted to accommodate, for example, the radiation image storage panel 513 shown in FIGS. 6A and 6B having the specific shape region. FIG. 10 is a sectional view taken on line X-X of FIG. 9.

As illustrated in FIG. 9, a cassette 70′ comprises a panel accommodating section 71′, which is formed within the cassette 70′, and the cover member 72, which is located at one end of the cassette 70′ and which is capable of being opened and closed. The radiation image storage panel 513 is inserted into and taken out from the panel accommodating section 71′ in the state, in which the cover member 72 is open as illustrated in FIG. 9. As illustrated in FIG. 10, the panel accommodating section 71′ has a shape such that, when the radiation image storage panel 513 is located with the front surface 50d facing the front surface 70a of the cassette 70′, the radiation image storage panel 513 is capable of being accommodated in the panel accommodating section 71′, and such that, when the radiation image storage panel 513 is located with the front surface 50d and the back surface 50c being reversed, the radiation image storage panel 513 cannot be completely accommodated in the panel accommodating section 71′. Specifically, as illustrated in FIG. 10, the shape of the panel accommodating section 71′ is set so as to coincide in whole or in part with the shape of the radiation image storage panel 513 taken in the state, in which the radiation image storage panel 513 is accommodated in the panel accommodating section 71′ with the front surface 50d of the radiation image storage panel 513 facing the front surface 70a of the cassette 70′. In this embodiment, an elongated concave region 68, which coincides with the elongated convex region 67 acting as the specific shape region of the radiation image storage panel 513, is formed along the right side edge of the bottom surface of the panel accommodating section 71′, as viewed from above the front surface 70a of the cassette 70′.

Therefore, when the radiation image storage panel 513 is inserted into the panel accommodating section 71′ with the front surface 50d facing the front surface 70a of the cassette 70′, the radiation image storage panel 513 is capable of being completely accommodated in the panel accommodating section 71′. However, if it is attempted to insert the radiation image storage panel 513 into the panel accommodating section 71′ with the front surface 50d and the back surface 50c being reversed, the elongated convex region 67 of the radiation image storage panel 513 will be located at a position above the left side edge of the panel accommodating section 71′ in FIG. 10. In this state, the elongated convex region 67 cannot enter into the panel accommodating section 71′. Therefore, the radiation image storage panel 513 cannot be accommodated in the cassette 70′. Accordingly, the problems are capable of being prevented from occurring in that the radiation image storage panel 513 is accommodated in the cassette 70′ with the front surface 50d and the back surface 50c being reversed.

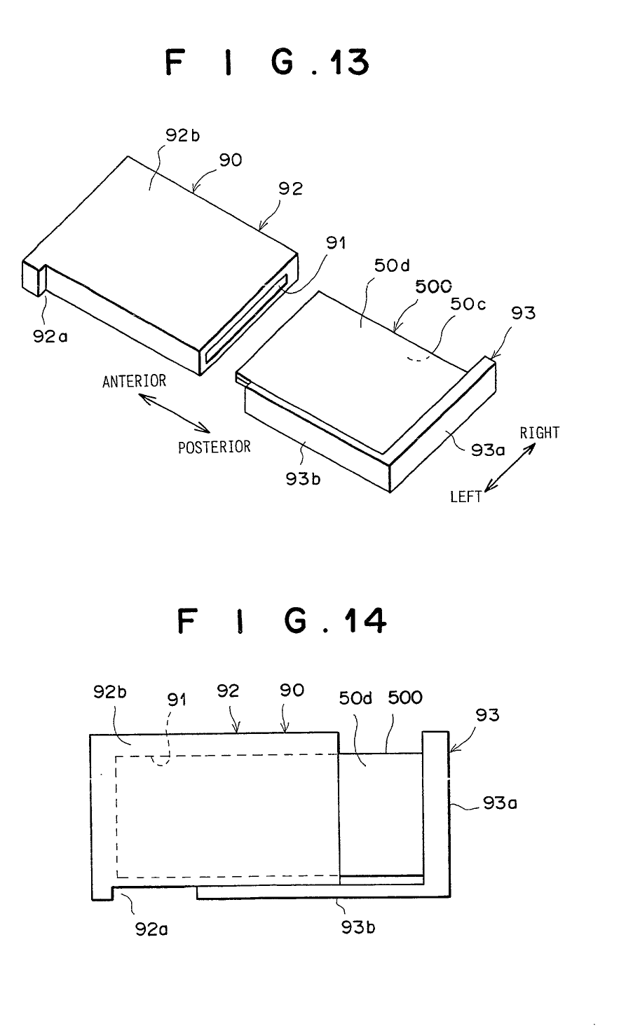

FIG. 11 is a perspective view showing a further different embodiment of the cassette in accordance with the present invention, wherein a radiation image storage panel is secured to part of the cassette. FIG. 12 is a partially cutaway side view showing the cassette of FIG. 11.

As illustrated in FIG. 11, a cassette 80 has a quadrangular shape. The cassette 80 is separated into a cassette main body 82, which is provided with a panel accommodating section 81, and a cassette sub-body 83, which is a flat plate-like member constituting one side face of the cassette 80. An end of the panel accommodating section 81 is open at the separation surface of the cassette main body 82. Also, an end of the radiation image storage panel 500 described above is secured to the separation surface of the cassette sub-body 83.

As illustrated in FIG. 12, the radiation image storage panel 500 is secured to the cassette sub-body 83 and at a position deviated from the middle point of the cassette sub-body 83, which middle point is taken with respect to the vertical direction of the cassette sub-body 83. Specifically, the radiation image storage panel 500 is secured at the position such that a distance Du between the front surface 50d of the radiation image storage panel 500 and a front surface 83a of the cassette sub-body 83 is different from a distance Dd between the back surface 50c of the radiation image storage panel 500 and a back surface 83b of the cassette sub-body 83 (i.e., Du≠Dd). (The front surface of each of the cassette main body 82, the cassette sub-body 83, and a cassette main body 92 which will be described later, is the surface facing the radiation source in the radiation image recording operation, and the back surface is the surface opposite to the surface facing the radiation source in the radiation image recording operation.) Also, the panel accommodating section 81 is formed in the cassette main body 82 such that the distance between a front surface 82a of the cassette main body 82 and the surface of the panel accommodating section 81 on the side of the front surface 82a is approximately equal to the distance Du, and such that the distance between a back surface 82a of the cassette main body 82 and the surface of the panel accommodating section 81 on the side of the back surface 82a is approximately equal to the distance Dd. As described above, the position of the radiation image storage panel 500 is deviated from the middle point of the cassette sub-body 83, which middle point is taken with respect to the vertical direction of the cassette sub-body 83. Therefore, the shape of the cassette sub-body 83, which shape is taken with respect to the radiation image storage panel 500, varies between when the radiation image storage panel 500 is located with the front surface 50d of the radiation image storage panel 500 facing up and when the radiation image storage panel 500 is located with the back surface 50c of the radiation image storage panel 500 facing up. (Specifically, when the radiation image storage panel 500 is located with the front surface 50d facing up, the height of the portion of the cassette sub-body 83, which portion projects upwardly from the upper surface of the radiation image storage panel 500, is equal to the distance Du. Also, when the radiation image storage panel 500 is located with the back surface 50c facing up, the height of the portion of the cassette sub-body 83, which portion projects upwardly from the upper surface of the radiation image storage panel 500, is equal to the distance Dd. Thus the shape of the cassette sub-body 83, which shape is taken with respect to the radiation image storage panel 500, varies between the two cases.)

The cassette 80 is constituted in the manner described above. Therefore, as indicated by the solid line in FIG. 12, in cases where the radiation image storage panel 500 is accommodated in the panel accommodating section 81 with the front surface 50d of the radiation image storage panel 500 facing up toward the side of the front surface 82a of the cassette main body 82, the shape of the cassette main body 82 and the shape of the cassette sub-body 83 coincide with each other. Specifically, the upper surface of the cassette main body 82 and the upper surface of the cassette sub-body 83 become flush with each other. Also, the lower surface of the cassette main body 82 and the lower surface of the cassette sub-body 83 become flush with each other. However, as indicated by the double-dot chained line in FIG. 12, in cases where the radiation image storage panel 500 is accommodated in the panel accommodating section 81 with the front surface 50d and the back surface 50c of the radiation image storage panel 500 being reversed, the shape of the cassette main body 82 and the shape of the cassette sub-body 83 do not coincide with each other. Specifically, the upper surface of the cassette main body 82 and the upper surface of the cassette sub-body 83 do not become flush with each other. Also, the lower surface of the cassette main body 82 and the lower surface of the cassette sub-body 83 do not become flush with each other.

More specifically, in cases where the radiation image storage panel 500 is accommodated in the panel accommodating section 81 with the front surface 50d and the back surface 50c of the radiation image storage panel 500 being reversed, since the shape of the cassette main body 82 and the shape of the cassette sub-body 83 do not coincide with each other, the user is capable of finding that the radiation image storage panel 500 has been accommodated with the back surface 50c facing up. Also, the combination shape of the cassette main body 82 and the cassette sub-body 83 varies between when the radiation image storage panel 500 is accommodated with the front surface 50d facing up and when the radiation image storage panel 500 is accommodated with the back surface 50c facing up. Therefore, the combination shape, which occurs when the radiation image storage panel 500 is accommodated with the back surface 50c facing up, maybe recognized previously. In such cases, when the radiation image storage panel 500 is accommodated with the back surface 50c facing up, the user is capable of finding from the combination shape that the radiation image storage panel 500 has been accommodated with the back surface 50c facing up. Accordingly, the problems are capable of being prevented from occurring in that the radiation image storage panel 500 is accommodated in the cassette 80 with the front surface 50d and the back surface 50c being reversed.

FIG. 13 is a perspective view showing a still further different embodiment of the cassette in accordance with the present invention, wherein a radiation image storage panel is secured to part of the cassette. FIG. 14 is a plan view showing a state in which the radiation image storage panel has been introduced to an intermediate point in the cassette of FIG. 13.

As illustrated in FIG. 13, a cassette 90 has a quadrangular shape. The cassette 90 is separated into the cassette main body 92, which is provided with a panel accommodating section 91, and a cassette sub-body 93, which is an L-shaped member constituting two adjacent side faces of the cassette 90. The L-shaped cassette sub-body 93 comprises a first side face member 93a and a second side face member 93b. An end of the panel accommodating section 91 is open at the separation surface of the cassette main body 92, which separation surface corresponds to the first side face member 93a, Also, a concave region 92a corresponding to the second side face member 93b is formed on the left side of the cassette main body 92 due to the separation of the second side face member 93b from the cassette 90. An end of the radiation image storage panel 500 described above is secured to the separation surface of the first side face member 93a,

As described above, the cassette sub-body 93 has the L-shape and comprises the first side face member 93a and the second side face member 93b, and the radiation image storage panel 500 is secured to the first side face member 93a, Therefore, the shape of the cassette sub-body 93, which shape is taken with respect to the radiation image storage panel 500, varies between when the radiation image storage panel 500 is located with the front surface 50d of the radiation image storage panel 500 facing up and when the radiation image storage panel 500 is located with the back surface 50c of the radiation image storage panel 500 facing up. (Specifically, when the radiation image storage panel 500 is located with the front surface 50d facing up, the second side face member 93b is located on the left side of the radiation image storage panel 500. Also, when the radiation image storage panel 500 is located with the back surface 50c facing up, the second side face member 93b is located on the right side of the radiation image storage panel 500.)

The cassette 90 is constituted in the manner described above. Therefore, as indicated by the solid line in FIG. 14, in cases where the radiation image storage panel 500 is accommodated in the panel accommodating section 91 with the front surface 50d of the radiation image storage panel 500 facing up toward the side of a front surface 92b of the cassette main body 92, the second side face member 93b of the cassette sub-body 93 fits into the concave region 92a of the cassette main body 92, the shape of the cassette main body 92 and the shape of the cassette sub-body 93 thus coincide with each other, and the radiation image storage panel 500 is capable of being accommodated in the cassette 90. However, in cases where it is attempted to accommodate the radiation image storage panel 500 in the panel accommodating section 91 with the front surface 50d and the back surface 50c of the radiation image storage panel 500 being reversed, the anterior end of the second side face member 93b strikes against the right end of the separation surface of the cassette main body 92, the shape of the cassette main body 92 and the shape of the cassette sub-body 93 do not coincide with each other, and the radiation image storage panel 500 cannot be accommodated in the cassette 90. Accordingly, the problems are capable of being prevented from occurring in that the radiation image storage panel 500 is accommodated in the cassette 90 with the front surface 50d and the back surface 50c being reversed.

The radiation image storage panel in accordance with the present invention aims at achieving the discrimination of the front and back surfaces by setting the asymmetric shape of the radiation image storage panel, forming the colored region, or forming the specific shape region. The kind of the asymmetric shape, the mode of the colored region, the mode of provision of the specific shape region, and the like, are not limited to those in the embodiments described above and maybe selected arbitrarily such that the discrimination of the front and back surfaces of the radiation image storage panel is capable of being achieved.

Also, in the cassette in accordance with the present invention, the shape of the accommodating section may be selected arbitrarily from various shapes such that, due to the asymmetric shape or the specific shape region of the radiation image storage panel, the radiation image storage panel cannot be accommodated with the front and back surfaces of the radiation image storage panel being reversed, i.e. with the back surface of the radiation image storage panel facing the front surface side of the cassette.

Further, with the cassette in accordance with the present invention, the cassette maybe separated into the cassette main body and the cassette sub-body, the radiation image storage panel may be secured to the cassette sub-body, and the shape of the cassette sub-body, which shape is taken with respect to the radiation image storage panel, may vary between when the radiation image storage panel is located with the front surface of the radiation image storage panel facing up and when the radiation image storage panel is located with the back surface of the radiation image storage panel facing up. In this manner, the state, in which the radiation image storage panel is located with the front and back surfaces being reversed, is capable of being recognized in accordance with the shape of the cassette sub-body. Alternatively, due to the shape of the cassette sub-body, the radiation image storage panel is prevented from being accommodated in the cassette with the front and back surfaces of the radiation image storage panel being reversed. In such cases, the separation of the cassette main body and the cassette sub-body may be performed in one of various ways, such that the effects described above are capable of being obtained. Also, the securing of the radiation image storage panel to the cassette sub-body may be performed in one of various ways. Though not shown, in the cases of the cassette separated into the cassette main body and the cassette sub-body, an appropriate locking mechanism may be provided for locking the cassette main body and the cassette sub-body to each other after the radiation image storage panel has been accommodated in the panel accommodating section of the cassette main body.

In the embodiments described above, the radiation image storage panel is utilized primarily for the operation for detecting light emitted from the front and back surfaces of the radiation image storage panel and thereby detecting two image signals from the opposite surfaces of the radiation image storage panel. However, the radiation image storage panel provided with the transparent substrate in accordance with the present invention is not limited to the radiation image storage panel utilized for the operation for detecting light emitted from the front and back surfaces of the radiation image storage panel and thereby detecting two image signals from the opposite surfaces of the radiation image storage panel. The radiation image storage panel in accordance with the present invention may be the radiation image storage panel utilized for an operation for detecting light emitted from the stimulable phosphor layer side alone and thereby detecting only one image signal from the stimulable phosphor layer side.

What is claimed is:

1. A radiation image storage panel having a rectangular shape, comprising a transparent substrate and a stimulable phosphor layer overlaid on a front surface side of the transparent substrate,
wherein the shape of the radiation image storage panel is asymmetric with respect to a center axis of the radiation image storage panel, which center axis extends in an antero-posterior direction of the radiation image storage panel.

2. A radiation image storage panel as defined in claim 1 wherein a shape of one corner area, which is among four corner areas of the radiation image storage panel, is different from shapes of the other three corner areas.

3. A radiation image storage panel as defined in claim 1 wherein shapes of two corner areas, which are among four corner areas of the radiation image storage panel and which are located on one of two diagonal lines, are identical with each other and are different from shapes of the other two corner areas, which are located on the other diagonal line.

4. A radiation image storage panel as defined in claim 1 wherein one of a cutaway region, a projecting region, and a hole is formed only at one corner area, which is among four corner areas of the radiation image storage panel, or in the vicinity of the one corner area.

5. A radiation image storage panel as defined in claim 1 wherein one of a cutaway region, a projecting region, and a hole is formed only at each of two corner areas, which are among four corner areas of the radiation image storage panel and which are located on one of two diagonal lines, or in the vicinity of each of the two corner areas.

6. A radiation image storage panel having a rectangular shape, comprising a transparent substrate and a stimulable phosphor layer overlaid on a front surface side of the transparent substrate,
wherein a colored region is formed on only either one of a front surface and a back surface of the radiation image storage panel.

7. A radiation image storage panel having a rectangular shape, comprising a transparent substrate and a stimulable phosphor layer overlaid on a front surface side of the transparent substrate,
wherein a colored region is formed on each of a front surface and a back surface of the radiation image storage panel, and
the colored region formed on the front surface of the radiation image storage panel and the colored region formed on the back surface of the radiation image storage panel differ from each other in position, shape, and/or color.

8. A radiation image storage panel as defined in claim 6 or 7 wherein the colored region, which is formed on the front surface of the radiation image storage panel, has a color other than colors, which are capable of absorbing stimulating rays irradiated to the radiation image storage panel and light emitted from the radiation image storage panel when the radiation image storage panel is exposed to the stimulating rays.

9. A radiation image storage panel as defined in claim 6 or 7 wherein the colored region, which is formed on the back surface of the radiation image storage panel, has a color other than colors, which are capable of absorbing light emitted from the radiation image storage panel when the radiation image storage panel is exposed to stimulating rays.

10. A radiation image storage panel having a rectangular shape, comprising a transparent substrate and a stimulable phosphor layer overlaid on a front surface side of the transparent substrate,
wherein the radiation image storage panel is provided with a specific shape region which acts such that a shape on a front surface of the radiation image storage panel and a shape on a back surface of the radiation image storage panel differ from each other.

11. A cassette, comprising an accommodating section for accommodating a radiation image storage panel as defined in claim 1,
wherein the accommodating section has a shape such that, due to the asymmetric shape of the radiation image storage panel, the radiation image storage panel is prevented from being accommodated in the accommodating section with a front surface and a back surface of the radiation image storage panel being reversed.

12. A cassette, comprising an accommodating section for accommodating a radiation image storage panel as defined in claim 10,
wherein the accommodating section has a shape such that, due to the specific shape region of the radiation image storage panel, the radiation image storage panel is prevented from being accommodated in the accommodating section with the front surface and the back surface of the radiation image storage panel being reversed.

13. A cassette, comprising an accommodating section for accommodating a radiation image storage panel, which radiation image storage panel comprises a transparent substrate and a stimulable phosphor layer overlaid on a front surface side of the transparent substrate,
wherein the cassette is separated into a cassette main body and a cassette sub-body,
the radiation image storage panel is secured to the cassette sub-body, and
the shape of the cassette sub-body, which shape is taken with respect to the radiation image storage panel, varies between when the radiation image storage panel is located with a front surface of the radiation image storage panel facing up and when the radiation image storage panel is located with a back surface of the radiation image storage panel facing up.
